(19) United States
(12) Patent Application Publication
(10) Pub. No.: US 2015/0282092 A1
(43) Pub. Date: Oct. 1, 2015

(54) TERMINAL DEVICE

(71) Applicant: SHARP KABUSHIKI KAISHA, Osaka-shi, Osaka (JP)

(72) Inventors: Osamu Nakamura, Osaka-shi (JP); Hiroki Takahashi, Osaka-shi (JP); Jungo Goto, Osaka-shi (JP); Kazunari Yokomakura, Osaka-shi (JP); Yasuhiro Hamaguchi, Osaka-shi (JP)

(73) Assignee: SHARP KABUSHIKI KAISHA, Osaka-shi, Osaka (JP)

(21) Appl. No.: 14/440,494

(22) PCT Filed: Oct. 31, 2013
(86) PCT No.: PCT/JP2013/079630

§ 371 Date: May 4, 2015

(30) Foreign Application Priority Data
Nov. 5, 2012 (JP) 2012-243441

(51) Int. Cl. H04W 52/04; H04W 16/32; H04L 5/00

(52) U.S. Cl. CPC H04W 52/04; H04L 5/0055; H04L 5/0057; H04W 16/32; H04W 88/08

(57) ABSTRACT

There has been a problem that when transmit power control is performed so as to compensate for a certain pathloss regardless of a type of a transmit signal, reception is not performed at a receiving end with an appropriate receive power in a case where a destination differs depending on a type of a transmit power. A terminal device includes a transmit power control unit that determines a transmit power. The transmit power control unit includes at least two types of transmit power equations which are used in determining the transmit power, determines the transmit power based on one of the equations when a scheduling request is transmitted to one of the multiple base stations, and determines the transmit power based on the other equation that is different from the one equation when information is transmitted to an another one of the base stations. The terminal device includes a transmission unit that transmits data based on the determined transmit power.

### TECHNICAL FIELD

The present invention relates to a terminal device.

### BACKGROUND ART

In the Third Generation Partnership Project (3GPP) that is one of standardization organizations, standardization of 3GPP long-term evolution (LTE) Rel-10 (Systems after LTE Rel-10 may be called LTE-Advanced (LTE-A).) that is one of fourth generation mobile communication systems is nearly completed, and standardization of LTE Rel-11 that is an expansion of LTE Rel-10 is currently under way.

In mobile communication systems such as LTE, transmit power control (TPC) for terminal devices is generally applied. TPC compensates for pathloss between a base station and a terminal. The purposes of TPC are, for example, to reduce power consumption incurred by a terminal close to a base station performing transmission at an excessively high transmit power, to reduce interference to other cells, and to further suppress interference between codes in a case where code division multiple access (CDMA) is applied.

Meanwhile, a review of a system called Rel-12 is also started. There is suggested a technology (for example, in NPL 1) in which multiple small cells are configured by installing low-power base stations (low-power nodes (LPN) or pico base stations) in a macro area that a base station apparatus (macro base station) in the related art covers, and the macro base station instructs a terminal device that desires high-speed data transmission to connect to the LPN so as to offload a traffic and increase the capacity in the macro area.

### CITATION LIST

### Non Patent Literature

NPL 1: Ericsson, RWS-120003, 3GPP RAN Workshop on Rel-12 and onwards, June, 2012

### SUMMARY OF INVENTION

### Technical Problem

A case is considered where the terminal device and the LPN are instructed to make a connection with the LPN, not with the macro base station, in order that the terminal device notifies the macro base station of a scheduling request (SR) by using a control channel, and the macro base station offloads a traffic. The terminal device transmits the SR with a transmit power that the macro base station can demodulate, but among signals other than the SR (for example, a control information or data signal and a reference signal), there are signals that are transmitted to the LPN. When the transmit power is configured with consideration of pathloss between the macro base station and the terminal device, signals are not received in the LPN at an appropriate power. Thus, a system throughput is decreased due to interference.

The present invention is devised with consideration of the above problem, and an object thereof is to perform appropriate transmit power control by changing a pathloss value depending on a transmit signal and to increase a system throughput.

### Solution to Problem

In order to resolve the above-described problem, a configuration of a terminal device according to the present invention is as follows.

(1) According to an aspect of the present invention, there is provided a terminal device that is connectable to multiple base stations, the terminal device including a transmit power control unit that determines a transmit power, in which the transmit power control unit has at least two types of transmit power equations which are used in determining the transmit power, determines the transmit power based on one of the equations when a scheduling request is transmitted to one of the multiple base stations, and determines the transmit power based on the other equation that is different from the one equation when information is transmitted to an another one of the multiple base stations, and the terminal device includes a transmission unit that transmits data based on the determined transmit power.

(2) Further, according to an aspect of the present invention, the information is a data signal.

(3) Further, according to an aspect of the present invention, the information is a CQI or an ACK/NAK.

(4) Further, according to an aspect of the present invention, the equation and the other equation have different pathloss values.

### Advantageous Effects of Invention

According to the invention, cell throughput can be increased because transmit power control can be appropriately performed regardless of types of transmit signals.

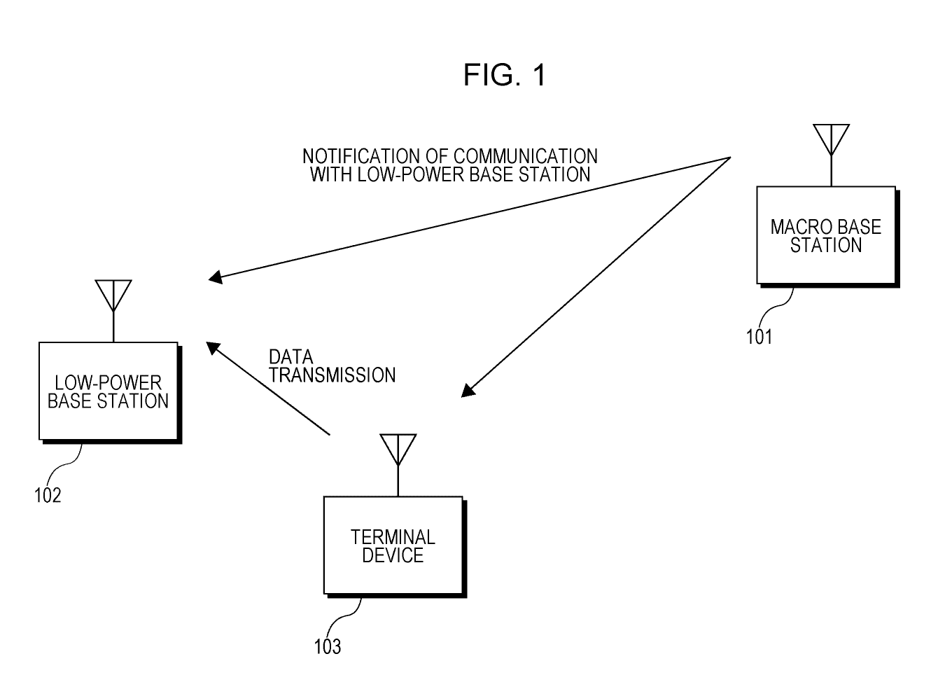

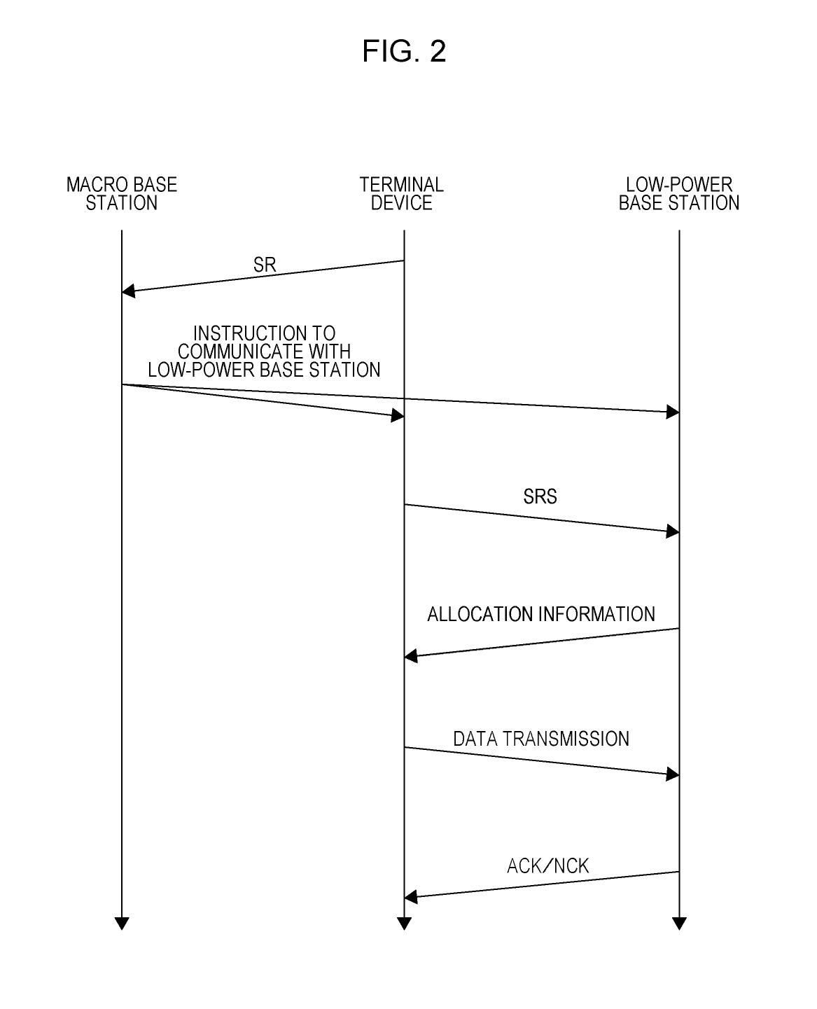

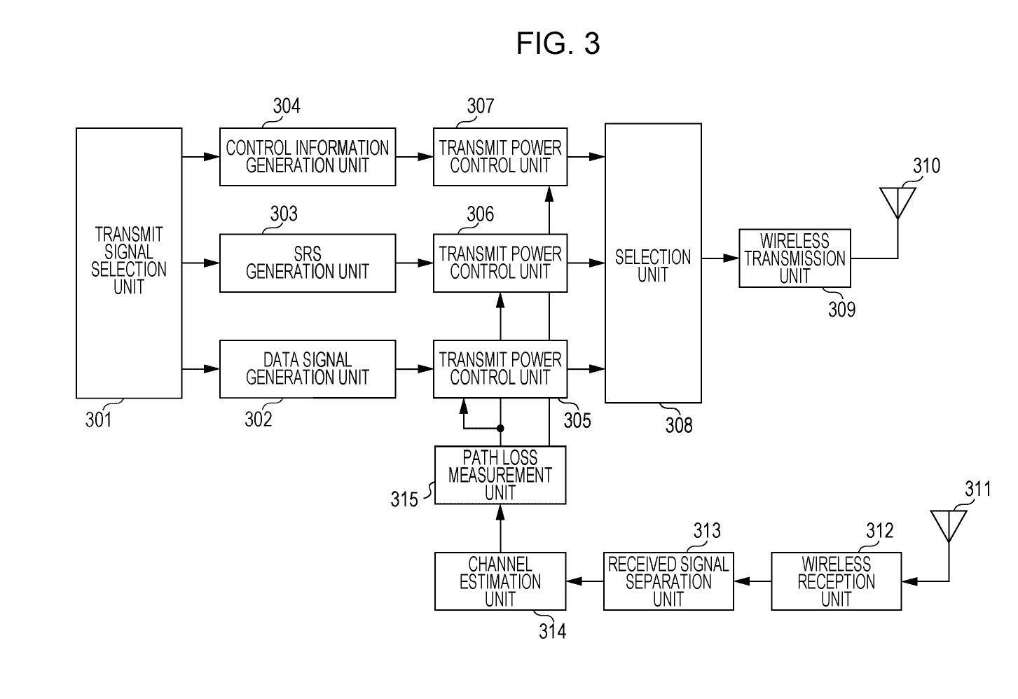

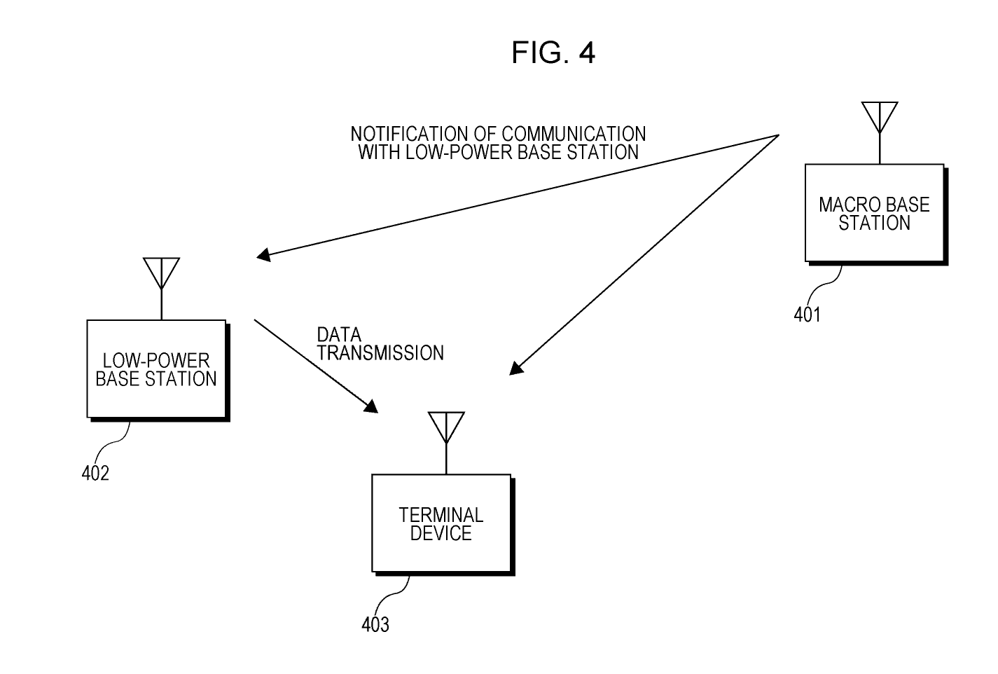

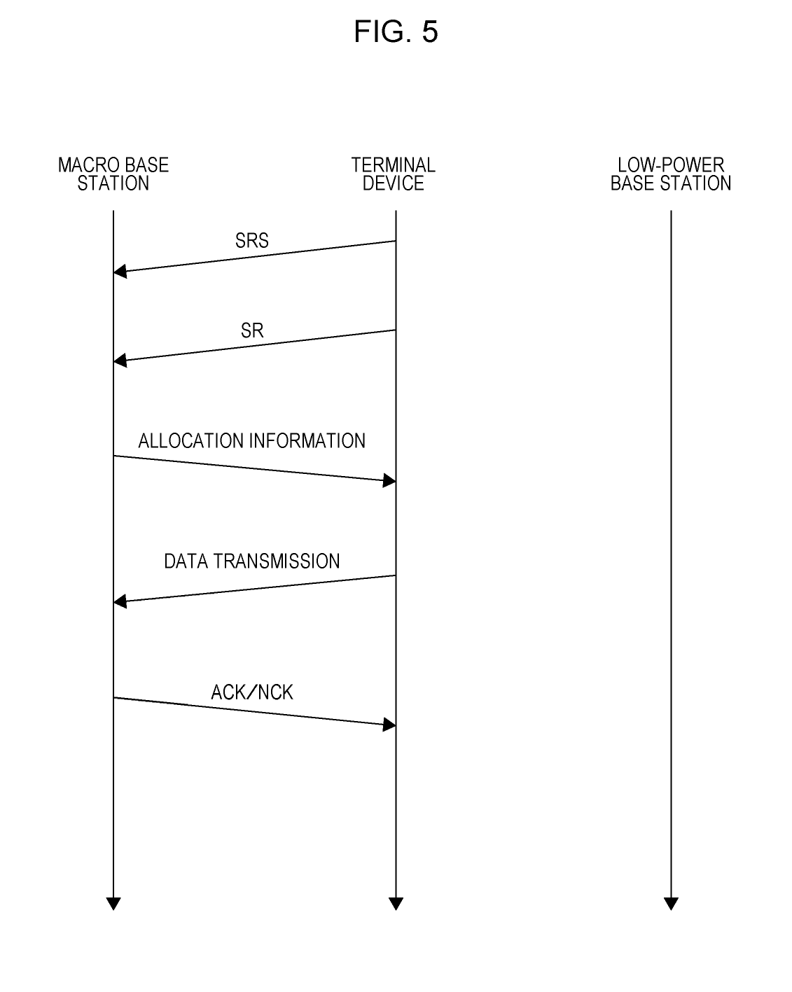

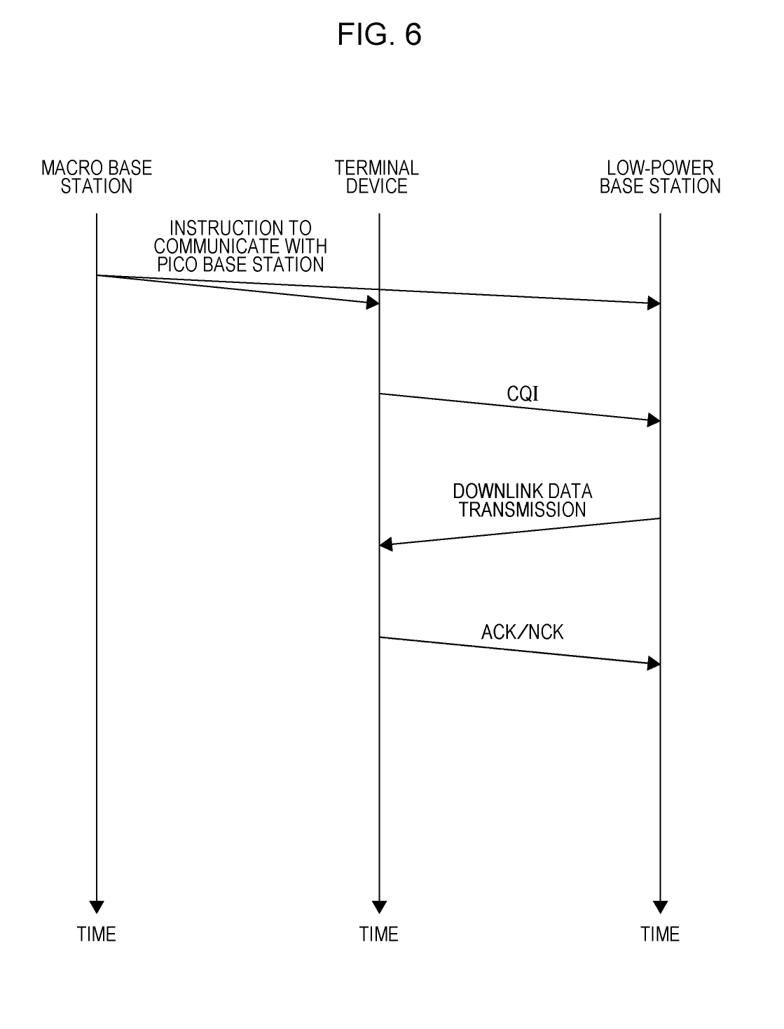

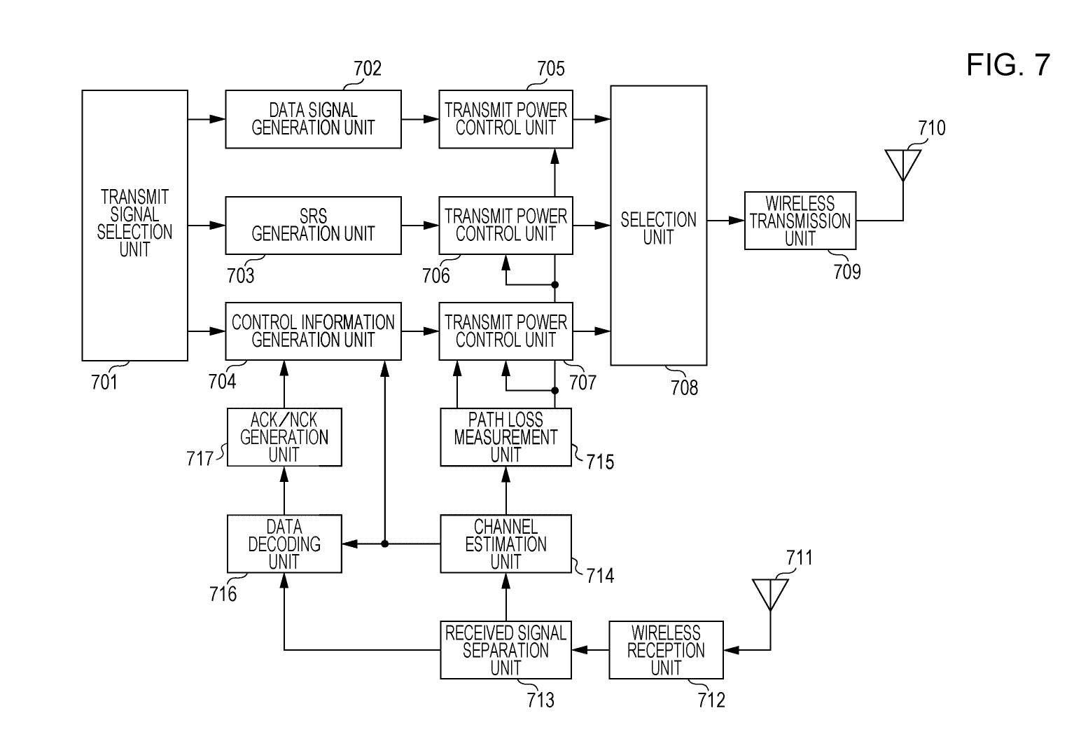

### BRIEF DESCRIPTION OF DRAWINGS

[FIG. 1] FIG. 1 is a schematic block diagram illustrating a configuration of a wireless communication system in a first embodiment of the present invention.

[FIG. 2] FIG. 2 is an uplink sequence chart in the first embodiment of the present invention.

[FIG. 3] FIG. 3 is a schematic block diagram illustrating a configuration of a terminal device in the first embodiment of the present invention.

[FIG. 4] FIG. 4 is a schematic block diagram illustrating a configuration of a wireless communication system in a second embodiment of the present invention.

[FIG. 5] FIG. 5 is an uplink sequence chart in the second embodiment of the present invention.

[FIG. 6] FIG. 6 is a downlink sequence chart in the second embodiment of the present invention.

[FIG. 7] FIG. 7 is a schematic block diagram illustrating a configuration of a terminal device in the second embodiment of the present invention.

### DESCRIPTION OF EMBODIMENTS

Hereinafter, embodiments of the present invention will be described in detail with reference to the drawings.

### First Embodiment

Hereinafter, a first embodiment of the present invention will be described with reference to the drawings. FIG. 1 illustrates an example of a system configuration in the present embodiment. The system is configured by a macro base station 101, an LPN 102 (also called a low-power base station or a pico base station), and a terminal device 103. The macro base station 101 configures a macro area that covers a wide range in the same manner as a cellular system in the related art. The LPN 102 is installed in the cell that the macro base station 101 configures. The LPN 102 configures a cell having a small cell radius (also called a small cell) in the macro area. Although one LPN and one terminal device are illustrated in FIG. 1, multiple LPNs and multiple terminal devices may exist in the macro area. In the present embodiment, a case is assumed where the terminal device 103 transmits uplink data (physical uplink shared channel (PUSCH)) to the LPN 102 according to an instruction from the macro base station 101.

FIG. 2 illustrates a sequence chart when the terminal device 103 transmits data to the LPN 102. First, the terminal device 103 transmits an SR to the macro base station by using a control channel (physical uplink control channel (PUCCH)). The macro base station 101 transmits to the terminal device 103 and the LPN 102 a signal that instructs to perform uplink data transmission between the LPN 102 and the terminal device 103. The terminal device 103 transmits a sounding reference signal (SRS) in order for the LPN 102 to perform scheduling. Parameters used in SRS transmission may be notified from the macro base station 101 along with the instruction to connect to the LPN 102 or may be notified from the LPN 102 after the instruction to connect to the LPN 102. The notification may also be performed in advance from the LPN 102. The LPN 102 obtains a channel state between the terminal device 103 and the macro base station 101 by using the received SRS, allocates an appropriate resource (the resource is configured from a frequency and a time) to the terminal device 103, and notifies the terminal device 103 of the allocation information. The terminal device 103 performs data transmission by using the allocated resource. The LPN 102 performs a decoding process for the received data signal, determines whether a correct decoding result is obtained by using an added CRC code, and notifies the terminal device 103 of an ACK in a case that the decoding result is correct or an NAK in a case that the decoding result is incorrect.

FIG. 3 illustrates a configuration of the terminal device 103 in the present embodiment. A signal transmitted from the LPN 102 or the macro base station 101 is input into a wireless reception unit 312 through a receive antenna 311. The wireless reception unit 312 performs processes such as downconversion from a carrier frequency into a baseband and analog-to-digital (A/D) conversion and inputs into a received signal separation unit 313. The received signal separation unit 313 inputs received reference signals among the received signals into a channel estimation unit 314. The channel estimation unit 314 estimates channels between the terminal device 103 and transmit antennas of the macro base station 101 and the LPN 102 by using the reference signals transmitted from the macro base station 101 and the LPN 102 and respectively inputs into a pathloss measurement unit 315. The pathloss measurement unit 315 calculates a pathloss by using the input channel estimation values and transmit powers of the reference signals, which the terminal device 103 has, from the macro base station 101 and the LPN 102. The pathloss measurement unit 315 may perform pathloss measurement at all times for all base stations that may connect to the terminal device 103 or may measure the pathloss between the terminal device 103 and the LPN 102 after the notification of the instruction to communicate with the LPN 102 is received from the macro base station 101. The transmit power of the reference signal may be notified from the macro base station 101 or the LPN 102. The pathloss between the macro base station 101 is input into a transmit power control unit 307. The pathloss between the LPN is input into transmit power control units 305 to 307.

A transmit signal selection unit 301 performs input for operating one of a data signal generation unit 302, an SRS generation unit 303, and a control information generation unit 304 by using information, which the terminal device 103 has, on which signal is to be transmitted in the next transmission. The data signal generation unit 302, the SRS generation unit 303, and the control information generation unit 304 respectively generate a data signal, an SRS, and control information according to the input from the transmit signal selection unit 301. The signals generated by the data signal generation unit 302, the SRS generation unit 303, and the control information generation unit 304 are respectively input into the transmit power control units 305 to 307. The transmit power control units 305 to 307 perform transmit power control (TPC) according to the input from the pathloss measurement unit 315. Processes in the transmit power control units 305 to 307 will be described later. Outputs of the transmit power control units 305 to 307 are input into a selection unit 308. The selection unit 308 selects either one of the signals from the data signal generation unit 302, the SRS generation unit 303, and the control information generation unit 304 and inputs into a wireless transmission unit 309. The selection here is brought into accordance with the selection by the transmit signal selection unit 301. The wireless transmission unit 309 transmits a signal to the macro base station 101 or the LPN 102 through a transmit antenna 310 after performing digital-to-analog (D/A) conversion and upconversion from a baseband into a carrier frequency.

A description will be provided here for the transmit power control unit 307 that performs transmit power control of the control information. As illustrated by the sequence chart in FIG. 2, a scheduling request (SR) is control information that is transmitted to the macro base station 101 and is transmitted in PUCCH format 1 in LTE. According to the specification of LTE, the transmit power of PUCCH in an i-th subframe P_{PUCCH}(i) is determined as based on the following equation.

$${P}_{PUCCH} ( i ) = min \{ \begin{matrix}{P}_{CMAX , c} ( i ) , \\ \begin{matrix}{P}_{0 \_ PUCCH} + {PL}_{c} + h ( {n}_{CQI} , {n}_{HARQ} , {n}_{SR} ) + \\ {Δ}_{F\_PUCCH} ( F ) + {Δ}_{T \times D} ( {F}^{′} ) + g ( i )\end{matrix}\end{matrix} \} \qquad [ Equation 1 ]$$

Here, min(A, B) is a function of selecting one of A and B having a smaller value. P_{CMAX, c}(i) is an allowable maximum transmit power in a c-th carrier component. P_{O#PUCCH} is a target receive power value at the receiving end. Δ_{F#PUCCH}(F) is a correction value determined by a PUCCH format. h(n_{CQI}, n_{HARQ}, n_{SR}) is a correction value according to the number of transmission bits in a specified format. Δ_{TxD}(F′) is a correction value determined by whether transmit antenna diversity is performed. g(i) is a transmit power control value according to a TPC command. Accordingly, in the transmit power control in LTE, transmission is performed with a smaller power between the allowable transmit power P_{CMAX, c}(i) and the value used for appropriately controlling the transmit power.

PL_{c} in the present embodiment is a pathloss value in the c-th carrier component. Since the SR is transmitted to the macro base station 101, a pathloss value between the macro base station 101 and the terminal device 103 is used to compensate for the pathloss. Therefore, the pathloss measurement unit 315 inputs the pathloss value between the macro base station 101 and the terminal device 103 into the transmit power control unit 307.

Next, a description will be provided for the transmit power control unit 306 that performs transmit power control of an SRS. As illustrated in FIG. 2, the sounding reference signal (SRS) is a reference signal transmitted to the LPN 102. The LPN 102 allocates RBs that each terminal device uses by using the received SRS. The transmit power of an SRS in the i-th subframe in the c-th carrier component P_{SRS, c}(i) is determined as based on the following equation in LTE.

$${P}_{SRS , c} ( i ) = min \{ \begin{matrix}{P}_{CMAX , c} ( i ) , \\ \begin{matrix}{P}_{SRS\_OFFSET , c} ( m ) + 10 {log}_{10} ( {M}_{SRS , c} ) + \\ {P}_{O\_PUSCH} ( j ) + {α}_{c} ( j ) \cdot {PL}_{c} + {f}_{c} ( i )\end{matrix}\end{matrix} \} \qquad [ Equation 2 ]$$

Here, M_{SRS, c} is the transmission bandwidth of the SRS. P_{O#PUSCH}(j) is a target receive power value in the PUSCH. P_{SRS#OFFSET, c} is a difference between the SRS and the target receive power of the PUSCH. α_{c}(j) is a parameter for fractional TPC, and the same value as the PUSCH is used for α_{c}(j). f_{c}(i) is a transmit power control value according to a PUSCH TPC command.

Here, PL_{c} is a pathloss value in the c-th carrier component. Since the SRS is transmitted to the LPN 102 in the present embodiment, a pathloss value between the LPN 102 and the terminal device 103 is used to compensate for the pathloss. Therefore, the pathloss measurement unit 315 inputs the pathloss value between the LPN 102 and the terminal device 103 into the transmit power control unit 306. That is, a pathloss compensation value is differently used in the case of the PUCCH (SR) and in the case of the SRS.

In systems in the related art, since signals are transmitted to the same base station regardless of types of transmit signals, the same pathloss value can be used for transmission of all signals. However, in the system assumed in the present embodiment, since the destination (the macro base station 101 or the LPN 102) differs depending on types of transmit signals, signals may not be received with a predetermined power even after transmit power control is performed when the same pathloss value is used.

In the present embodiment, therefore, different pathloss values are used depending on transmit signals. That is, since the SR is transmitted to the macro base station 101, the pathloss between the macro base station 101 and the terminal device 103 is used. That is, the pathloss between the macro base station 101 and the terminal device 103 is used at all times as PL_{c} in Equation (1).

Meanwhile, transmit power control differs for the SRS depending on where the PUSCH is transmitted. Thus, the transmit power is determined as based on, for example, the following equation.

$${P}_{SRS , c} ( i ) = min \{ \begin{matrix}{P}_{CMAX , c} ( i ) , \\ \begin{matrix}{P}_{SRS\_OFFSET , c} ( m ) + 10 {log}_{10} ( {M}_{SRS , c} ) + \\ {P}_{O\_PUCCH} ( j ) + {α}_{c} ( j ) \cdot {PL}_{PUSCHc} + {f}_{c} ( i )\end{matrix}\end{matrix} \} \qquad [ Equation 3 ]$$

The difference from the TPC equation in the related art in Equation (2) is that PL_{c} is changed to PL_{PUSCH, c}. That is, a pathloss value to refer to differs depending on whether the PUSCH is transmitted to the macro base station 101 or is transmitted to the LPN 102. For example, in a case where the PUSCH is transmitted to the macro base station 101, the pathloss is measured by using the reference signal that the macro base station 101 transmits, and the measured value is used as the pathloss in PL_{PUSCH, c}. Meanwhile, in a case where the PUSCH is transmitted to the LPN 102, the pathloss is measured by using the reference signal (cell-specific RS (CRS), channel state information RS (CSI-RS), or the like) that the LPN 102 transmits, and the measured value is used as the pathloss in PL_{PUSCH, c}.

The SR is transmitted to the macro base station 101. Thus, the pathloss is calculated by using the reference signal such as the CRS or the CSI-RS that the macro base station 101 transmits, and transmit power control is performed by using the obtained pathloss.

While the example in which the pathloss value is calculated differently for the PUCCH and the SRS is illustrated above, the pathloss value is also calculated differently for the PUCCH and the PUSCH since the SRS and the PUSCH are transmitted to the same base station in the present embodiment. Description of this example will be omitted.

As described so far, a pathloss value is calculated differently for each signal depending on types of transmit signals (whether a signal is the PUCCH) in a case where the destination is different, and transmission is performed. Consequently, transmission is prevented from being performed with an excessive power or with an insufficient power. Thus, a cell throughput can be increased.

### Second Embodiment

The example in which the SR is transmitted to the macro base station, and the PUSCH is transmitted to the LPN, not the macro base station is illustrated in the first embodiment. In the present embodiment, a description will be provided for a case where the terminal device transmits a data signal to the macro base station through an uplink, and the LPN transmits a data signal to the terminal device through a downlink. FIG. 4 illustrates an example of a system configuration in the present embodiment. The system is configured by a macro base station 401, an LPN 402 (also called a low-power base station or a pico base station), and a terminal device 403. The macro base station 401 configures a macro area that covers a wide range in the same manner as a cellular system in the related art. The LPN 402 is installed in the cell that the macro base station 401 configures. The LPN 402 configures a cell having a small cell radius (also called a small cell) in the macro area. Although one LPN and one terminal device are illustrated in FIG. 4, multiple LPNs and multiple terminal devices may exist in the macro area. In the present embodiment, a case is assumed where the macro base station 401 performs data transmission to the terminal device through a downlink while the LPN 402 performs data transmission to the terminal device 403 through an uplink according to an instruction from the macro base station 401.

FIG. 5 illustrates a sequence chart of a case where the terminal device 403 transmits a data signal to the macro base station 401, that is, an uplink sequence chart. The terminal device 403 transmits an SRS to the macro base station 401 periodically or at a timing of receiving a notification from the macro base station 401. Furthermore, the terminal device 403 transmits an SR to the macro base station 401 by using a control channel (PUCCH) in order to notify the macro base station 401 of a request for transmitting data through an uplink. The macro base station 401, for example, allocates an uplink to the terminal device 403 and notifies the terminal device 403 of the allocation information. The terminal device 403 transmits a data signal to the macro base station 401 by using the PUSCH based on the allocation information notified from the macro base station 401. The macro base station 401 decodes the received PUSCH, determines whether the decoding result is correct according to a cyclic redundancy check (CRC) code added to the PUSCH, and transmits an ACKnowledge (ACK) or a Negative AcK (NAK) to the terminal device 403.

FIG. 6 illustrates a sequence chart of a case where the LPN 402 transmits a data signal to the terminal device 403, that is, a downlink sequence chart. First, the macro base station 401 notifies the LPN 402 and the terminal device 403 that the LPN 402 performs data transmission to the terminal device 403. The terminal device 403 that receives the notification measures a downlink channel quality between the LPN 402 and the terminal device 403 by using the reference signal that the LPN 402 transmits and notifies the LPN 402 of a channel quality indicator (CQI). The LPN 402 transmits data to the terminal device 403 based on the CQI by using a physical downlink shared channel (PDSCH). The terminal device 403 decodes the PDSCH and transmits an ACK or an NAK to the LPN.

Here, a focus is on the PUCCH that is necessary for uplink and downlink data transmission. As illustrated in FIG. 5, the SR in the present embodiment is transmitted to the macro base station 401. Meanwhile, as illustrated in FIG. 6, the CQI and the ACK/NAK are transmitted to the LPN 402. Incidentally, the SR, the CQI, and the ACK/NAK are basically transmitted by the PUCCH (The CQI and the ACK/NAK may also be transmitted by the PUSCH.). The transmit power of the PUCCH in LTE is determined by the following equation as illustrated in the first embodiment.

$${P}_{PUCCH} ( i ) = min \{ \begin{matrix}{P}_{CMAX , c} ( i ) , \\ \begin{matrix}{P}_{0 \_ PUCCH} + {PL}_{c} + h ( {n}_{CQI} , {n}_{HARQ} , {n}_{SR} ) + \\ {Δ}_{F\_PUCCH} ( F ) + {Δ}_{T \times D} ( {F}^{′} ) + g ( i )\end{matrix}\end{matrix} \} \qquad [ Equation 4 ]$$

Although PL_{c} is the pathloss in the c-th component carrier, PL_{c} is desirably changed depending on transmitted information because different base stations are connected depending on the type of information transmitted in the PUCCH. A description will be provided hereinafter for a method of performing appropriate transmit power control regardless of the type of information transmitted in the PUCCH.

FIG. 7 illustrates a configuration of the terminal device 403 in the present embodiment. A signal transmitted from the LPN 402 or the macro base station 401 is input into a wireless reception unit 712 through a receive antenna 711. The wireless reception unit 712 performs processes such as downconversion from a carrier frequency into a baseband and A/D conversion and inputs into a received signal separation unit 713. The received signal separation unit 713 inputs, among the received signals, received reference signals into a channel estimation unit 714 and received data signals into a data decoding unit 716. The channel estimation unit 714 estimates a channel between the terminal device 403 and a transmit antenna of the macro base station 401 or a transmit antenna of the LPN 402 by using the reference signal transmitted from the macro base station 401 or the LPN 402, and inputs into a pathloss measurement unit 715 and the data decoding unit 716. The data decoding unit 716 compensates for the received data signals input from the received signal separation unit 713 by using the channel estimation value input from the channel estimation unit 714 and obtains transmission data. The obtained transmission data is input into an ACK/NAK generation unit 717. The ACK/NAK generation unit 717 determines whether the data is correct according to a CRC code added to the transmission data, generates an ACK or an NAK, and inputs into a control information generation unit 704.

A transmit signal selection unit 701 performs input for operating one of a data signal generation unit 702, an SRS generation unit 703, and the control information generation unit 704 depending on which signal is transmitted in the next transmission. The data signal generation unit 702, the SRS generation unit 703, and the control information generation unit 704 respectively generate a data signal, an SRS, and control information according to the input from the transmit signal selection unit 701. The signals generated by the data signal generation unit 702, the SRS generation unit 703, and the control information generation unit 704 are respectively input into transmit power control units 705 to 707. The transmit power control units 705 to 707 perform transmit power control according to the input from the pathloss measurement unit 715. Pathloss estimation in the transmit power control units 705 to 707 and in the pathloss measurement unit 715 will be described later. Outputs of the transmit power control units 705 to 707 are input into a selection unit 708. The selection unit 708 selects either on of signals from the data signal generation unit 702, the SRS generation unit 703, and the control information generation unit 704 and inputs the signal into a wireless transmission unit 709. The selection here is brought into accordance with the selection by the transmit signal selection unit 701. The wireless transmission unit 709 transmits a signal to the macro base station 401 or the LPN 402 through a transmit antenna 710 after performing digital-to-analog (D/A) conversion and upconversion from a baseband into a carrier frequency.

Next, a description will be provided for processes in the pathloss measurement unit 715 and the transmit power control units 705 to 707. First, the transmit power control unit 705 and the transmit power control unit 706 will be described. Each of the transmit power control unit 705 and the transmit power control unit 706 performs transmit power control of a data signal and the SRS. Since the uplink is used in transmission to the macro base station 401 in the present embodiment, the transmit power control unit 705 and the transmit power control unit 706 may desirably perform transmit power control in the same manner as LTE according to an input value after receiving input of a pathloss value between the macro base station 401 and the terminal device 403 from the pathloss measurement unit 715.

The SR, the CQI, and the ACK/NAK exist in the information transmitted by the PUCCH as described previously. In a case where the LPN 402 performs downlink data transmission as in the present embodiment, a base station that is a destination of the transmission differs depending on the type of information. When the same transmit power control is performed for the PUCCH in the same manner as LTE regardless of different transmission destinations, consequently appropriate transmit power control is not performed. Therefore, in the present embodiment, a transmit power is determined by a different equation depending on the type of information transmitted by the PUCCH. An example of the equation for transmit power control is illustrated as follows.

$$\{ \begin{matrix}{P}_{SR} ( i ) = min \{ \begin{matrix}{P}_{CMAX , c} ( i ) , \\ \begin{matrix}{P}_{0 \_ PUCCH} + {PL}_{Macro , c} + \\ h ( {n}_{CQI} , {n}_{HARQ} , {n}_{SR} ) + \\ {Δ}_{F\_PUCCH} ( F ) + {Δ}_{T \times D} ( {F}^{′} ) + g ( i )\end{matrix}\end{matrix} \} \\ {P}_{CQI} ( i ) = min \{ \begin{matrix}{P}_{CMAX , c} ( i ) , \\ \begin{matrix}{P}_{0 \_ PUCCH} + {PL}_{LPN , c} + \\ h ( {n}_{CQI} , {n}_{HARQ} , {n}_{SR} ) + \\ {Δ}_{F\_PUCCH} ( F ) + {Δ}_{T \times D} ( {F}^{′} ) + g ( i )\end{matrix}\end{matrix} \}\end{matrix} \qquad [ Equation 5 ]$$

As in the above equation, transmission is performed according to P_{SR}(i) in a case where the SR is transmitted, and transmission is performed according to _{PCQI}(i) in a case where other information (the CQI or the ACK/NAK) is transmitted. Even in a case where the CQI and the ACK/NAK are collectively transmitted, transmission is performed according to P_{CQI}(i). Different pathloss values are set for the P_{SR}(i) and the P_{CQI}(i). Since the SR is transmitted to the macro base station 401, the pathloss measurement unit 715 measures the pathloss between the macro base station 401 and the terminal device 403 and inputs into the transmit power control unit 707. Meanwhile, in the case of the present embodiment, since the terminal device 403 transmits an ACK/NAK to the LPN 402, the pathloss measurement unit 715 measures the pathloss between the LPN 402 and the terminal device 403 and inputs the calculated pathloss value into the transmit power control unit 707. P_{O#PUCCH} indicates a target receive power value at the receiving end, but destination base station apparatuses differ between a case where the SR is transmitted and a case where the other information is transmitted. Therefore, it is desirable to use different values for P_{O#PUCCH} depending on destination base station apparatuses. The value of P_{O#PUCCH}may be individually notified from each base station apparatus, or the macro base station instead of the LPN may notify the terminal device of a set value in the LPN.

Accordingly, the macro base station and the LPN can receive all PUCCHs with an appropriate receive power by changing the equation of transmit power control in an adaptive manner depending on information that is sent from the macro base station as a notification and indicates that data is transmitted from the LPN and types of transmission control information. Thus, interferences between terminal devices can be uniformed. Consequently, the PUCCH can be correctly decoded in the base station, and thus a system throughput can be increased.

A program that operates in the base station and the terminal according to the present invention is a program (a program that causes a computer to function) that controls a CPU and the like in order to realize the function of the above embodiments according to the present invention. Information that is processed in these apparatuses is temporarily accumulated in a RAM when being processed. Afterward, the information is stored on various ROMs and HDDs, read by the CPU as desired, modified, or written. As a recording medium that stores the program, any recording medium such as a semiconductor medium (for example, a ROM and a non-volatile memory card), an optical recording medium (for example, a DVD, an MO, an MD, a CD, and a BD), and a magnetic recording medium (for example, a magnetic tape and a flexible disk) may be used. Not only execution of a loaded program realizes the function of the above-described embodiments. The function of the present invention may be realized by the program in cooperation with an operating system or other application programs based on the instruction of the program.

When the program is distributed on the market, the program can be distributed as stored on a portable recording medium or can be transferred to a server computer that is connected through a network such as the Internet. In this case, the present invention also includes a storage device of the server computer. A part of or the entire base station and the terminal in the above-described embodiments may be typically realized as an LSI that is an integrated circuit. Each functional block of the base station and the terminal may be configured as an individual chip, or a part of or the entire functional blocks may be integrated into a chip. Circuit integration techniques are not limited to the LSI and may be realized by a dedicated circuit or a general-purpose processor. In a case where each functional block is integrated into a circuit, an integrated circuit control unit that controls these functional blocks is added.

Circuit integration techniques are not limited to the LSI and may be realized by a dedicated circuit or a general-purpose processor. When a circuit integration technology that replaces the LSI emerges due to progress in a semiconductor technology, an integrated circuit according to the technology may also be used.

The present invention is not limited to the above-described embodiments. It is apparent that application of the terminal of the present invention is not limited to a mobile station apparatus. The terminal can be applied to a stationary type or a non-movable type electronic device installed indoors or outdoors, for example, an AV system, a kitchen device, a cleaning and laundry device, an air-conditioning device, an office device, a vending machine, and other daily life devices.

While embodiments of the invention are described in detail so far with reference to the drawings, the specific configuration of the invention is not limited to the embodiments and also includes modifications of the embodiments to an extent without departing from the gist of the invention. In addition, various modifications can be carried out to the present invention within the scope of the claims. An embodiment obtained by appropriately incorporating technical means disclosed in each different embodiment is also included in the technical scope of the present invention. The technical scope of the present invention also includes a configuration in which constituents that are described in each embodiment above and accomplish the same effect are substituted with each other.

### INDUSTRIAL APPLICABILITY

The present invention is suitable for use in a wireless base station, a wireless terminal, a wireless communication system, and a wireless communication method.

### REFERENCE SIGNS LIST

101 MACRO BASE STATION
102 LPN
103 TERMINAL DEVICE
301 TRANSMIT SIGNAL SELECTION UNIT
302 DATA SIGNAL GENERATION UNIT
303 SRS GENERATION UNIT
304 CONTROL INFORMATION GENERATION UNIT
305-307 TRANSMIT POWER CONTROL UNIT
308 SELECTION UNIT
309 WIRELESS TRANSMISSION UNIT
310 TRANSMIT ANTENNA
311 RECEIVE ANTENNA
312 WIRELESS RECEPTION UNIT
313 RECEIVED SIGNAL SEPARATION UNIT
314 CHANNEL ESTIMATION UNIT
315 PATH LOSS MEASUREMENT UNIT
401 MACRO BASE STATION
402 LPN
403 TERMINAL DEVICE
701 TRANSMIT SIGNAL SELECTION UNIT
702 DATA SIGNAL GENERATION UNIT
703 SRS GENERATION UNIT
704 CONTROL INFORMATION GENERATION UNIT
705-707 TRANSMIT POWER CONTROL UNIT
708 SELECTION UNIT
709 WIRELESS TRANSMISSION UNIT
710 TRANSMIT ANTENNA
711 RECEIVE ANTENNA
712 WIRELESS RECEPTION UNIT
713 RECEIVED SIGNAL SEPARATION UNIT
714 CHANNEL ESTIMATION UNIT
715 PATH LOSS MEASUREMENT UNIT
716 DATA DECODING UNIT
717 ACK/NAK GENERATION UNIT

1. A terminal device that is connectable to multiple base stations, the terminal device comprising:
a transmit power control unit that determines a transmit power,
wherein the transmit power control unit
has at least two types of transmit power equations which are used in determining the transmit power,
determines the transmit power based on one of the equations when a scheduling request is transmitted to one of the multiple base stations, and
determines the transmit power based on the other equation that is different from the one equation when information is transmitted to an another one of the multiple base stations, and
the terminal device includes a transmission unit that transmits the information based on the determined transmit power.

2. The terminal device according to claim 1,
wherein the information is a data signal.

3. The terminal device according to claim 1,
wherein the information is a CQI or an ACK/NAK.

4. The terminal device according to claim 1,
wherein the equation and the other equation have different pathloss values.
